(19) United States
(12) Patent Application Publication
(10) Pub. No.: US 2007/0300304 A1
(43) Pub. Date: Dec. 27, 2007

(54) SIP washing machine

(75) Inventor: Tommy Lindgren, Vantaa (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/474,793

(22) Filed: Jun. 26, 2006

(51) Int. Cl. G06F 12/14

(52) U.S. Cl. 726/24

(57) ABSTRACT

An improved system and method for addressing issues raised by denial of service attacks. The present invention provides for a “SIP washing machine,” which acts as a SIP redirect server. The SIP washing machine asks a client contact to redirect its messages to a different IP address/other SIP server. “Fake” clients do not understand the redirection request, while valid clients understand the redirection request and act appropriately. Therefore, by acting as a redirect server, the SIP washing machine “cleans” the useless SIP traffic, while the operator's service continues to operate satisfactorily for legitimate users.

### FIELD OF THE INVENTION

The present invention relates generally to session initiation protocol (SIP). More particularly, the present invention relates to the protection of SIP-based services against Internet denial of service (DoS) attacks.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Unfortunately, DoS attacks are common in the Internet. DoS attacks essentially comprise the transmission of large amounts of useless traffic towards a specific server or access network. To date, many DoS attacks have been concentrated on web servers. DoS attacks have two powerful mechanisms disabling their targets. First, DoS attacks often involve setting up an enormous amount of transmission control protocol (TCP) connections with the server, causing the server to overload in generating and maintaining TCP states. This is commonly referred to as a SYN flood. Second, DoS attacks can generate a huge amount (on the scale of several Gbps) of useless traffic that simply overloads the access link of the target device.

Through the use of SIP signaling, DoS attacks can easily overwhelm and bring down SIP servers by transmission of a very large amount of SIP requests, for example in the form of fake registrations and/or invitations. In response to these requests, the target SIP server must make countless unnecessary database queries that would likely overload the SIP servers with little difficulty. In addition, the huge amounts of useless traffic alone can often block the SIP server's links with the Internet.

The options for dealing with DoS attacks, specifically involving SIP requests, are quite limited. Firewalls and ACL's cannot prevent DoS attacks, because a DoS attack can overload the firewall just as it can overload a web server in the event of a SYN flood. Additionally, in the event that the access link is congested by the attack, the target is efficiently paralyzed, even if the firewall is able to block the malicious traffic. The same problems also apply to session border controllers (SBCs) in voice over IP (VOIP) deployments.

The traffic of a DoS attack usually cannot be prevented in the IP core network, as the traffic of the attack is usually coming from thousands of different sources. This is commonly referred to as a distributed denial of service (DDOS) with random source IP addresses. Redirecting or blocking the routing of the target address of the attack to a black hole (referred to as sink hole routing) would remove the useless traffic, but it would also result in the targeted service being efficiently blocked from the Internet, as there would no longer be any routing between the Internet to the targeted service.

### SUMMARY OF THE INVENTION

The present invention involves the use of a server referred to as a “SIP washing machine.” The SIP washing machine of the present invention acts as SIP redirect server. In most cases, clients such as botnets that generate false SIP traffic simply transmit SIP messages without any stateful functionality. In the present invention, when the SIP washing machine asks a client to redirect its messages to a different IP address/other SIP server, the “fake” clients do not understand the redirection request, while valid clients understand the redirection request and act appropriately. Therefore, by acting as a redirect server, the SIP washing machine of the present invention “cleans” the useless SIP traffic, while the operator's service still works for legitimate users.

With the present invention, an operator's service can still be used from the Internet even during a DoS attack. Additionally, the present invention does not require any new functionality in SIP, and existing SIP clients still operate satisfactorily with the present invention. Although the concept of a washing machine is conventionally known in the TCP context, the present invention's application in a SIP context improves the functionality and effectiveness of DoS attack prevention.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of a DoS attack being initiated against a SIP server;

FIG. 2 is a depiction of traffic relating to the DoS attack being redirected to a SIP washing machine of the present invention;

FIG. 3 is a depiction of a SIP washing machine of the present invention transmitting a redirect request to malicious clients which have initiated the DoS attack;

FIG. 4 is a flow chart showing the implementation of various embodiments of the present invention; and

FIG. 5 is a schematic representation of circuitry that can appear in an electronic device involved in the implementation of the present invention.

### DETAILED DESCRIPTION OF VARIOUS EMBODIMENTS

The present invention involves the use of a SIP washing machine. The SIP washing machine acts as SIP redirect server. In most cases, clients such as botnets that generate false SIP traffic simply transmit SIP messages without any stateful functionality. In the present invention, when the SIP washing machine asks a client to redirect its messages to a different IP address/other SIP server, the “fake” clients do not understand the redirection request, while valid clients understand the redirection request and act appropriately. Therefore, by acting as a redirect server, the SIP washing machine of the present invention “cleans” the useless SIP traffic, while the operator's service still works for legitimate users.

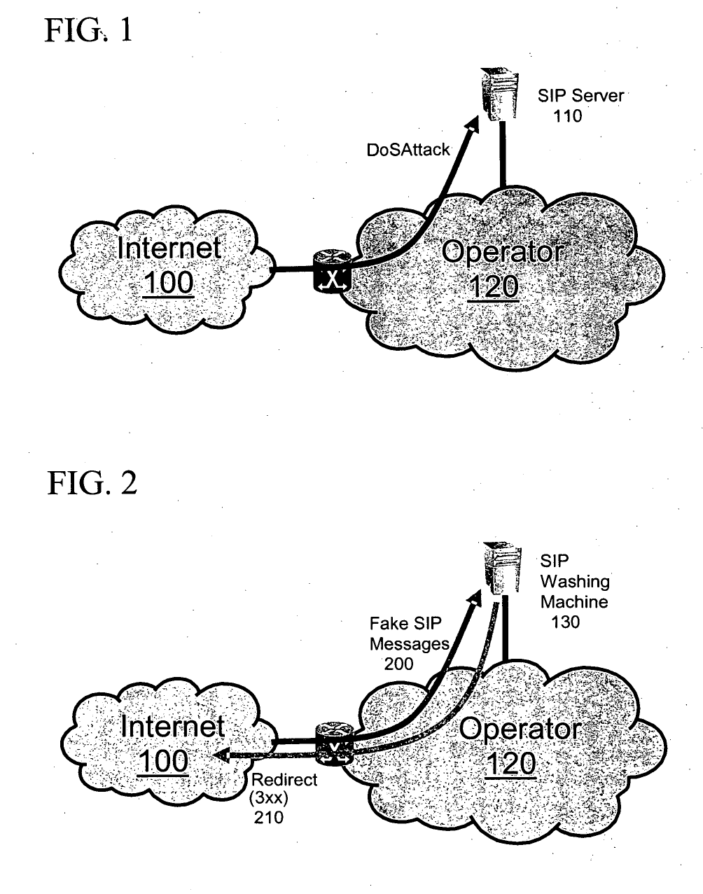

FIG. 1 is a representation showing the initiation of a DoS attack in progress. The generic system of FIG. 1 shows an attack being initiated from somewhere in the Internet 100 and being directed against a SIP server 110 of an operator 120. DoS attacks almost always come from the Internet 100 and not from the network of the operator 120. This is because the operator's own network typically includes mechanisms for filtering traffic by, for example, verifying the source addresses of traffic. However, such mechanisms do not work with regard to traffic coming from the Internet 100.

DoS attacks commonly comprise thousands of streams with random IP source addresses, with a single DoS attack often generating several Gbps of peak traffic. The load on the SIP server 110 increases due to fake SIP messages and/or a huge amount of user traffic that blocks the access link(s) to the SIP server 110. An incoming DoS attack can be recognized by conventionally known methods, e.g., from SIP proxy statistics or various commercial applications. One such commercial application is marketed under the name “Peakflow SP” and is sold by Arbor Networks.

In response to the DoS attack, and as shown in FIG. 2, all traffic that was originally targeting the SIP server 110 is redirected to a SIP washing machine 130 of the present invention. This can be accomplished, for example, by using existing methods such as IP routing protocols. The SIP washing machine 130 acts as a redirect server. The SIP washing machine 130 replies to all incoming SIP messages, asking the original senders to contact another SIP proxy, registrar or other SIP element. Because a DoS attack typically does not last for a long period, this functionality can be used only as needed, if so desired. This may be preferable in some implementations because the SIP washing machine 130 typically does not perform functions other than those described herein. The original SIP messages are represented at 200, and the reply by the SIP washing machine 130 are represented at 210.

In one embodiment of the invention, the SIP washing machine 130 is connected to the Internet 100 with a high capacity link, at least a gigabit Ethernet link in one embodiment, and is connected to an operator core node that is capable of handling the high amounts of traffic caused by the DoS attack.

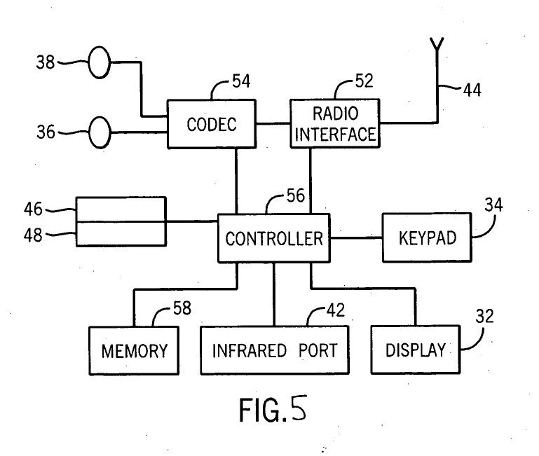

Because in various embodiments, the SIP washing machine 130 uses the IP address of the original SIP server 110 that was under attack, the SIP washing machine 130 cannot redirect the SIP traffic to the same address. The SIP requests can be either forwarded to another SIP server, as shown in FIG. 4 below, or the original SIP server 110 could include another (backup) IP address.

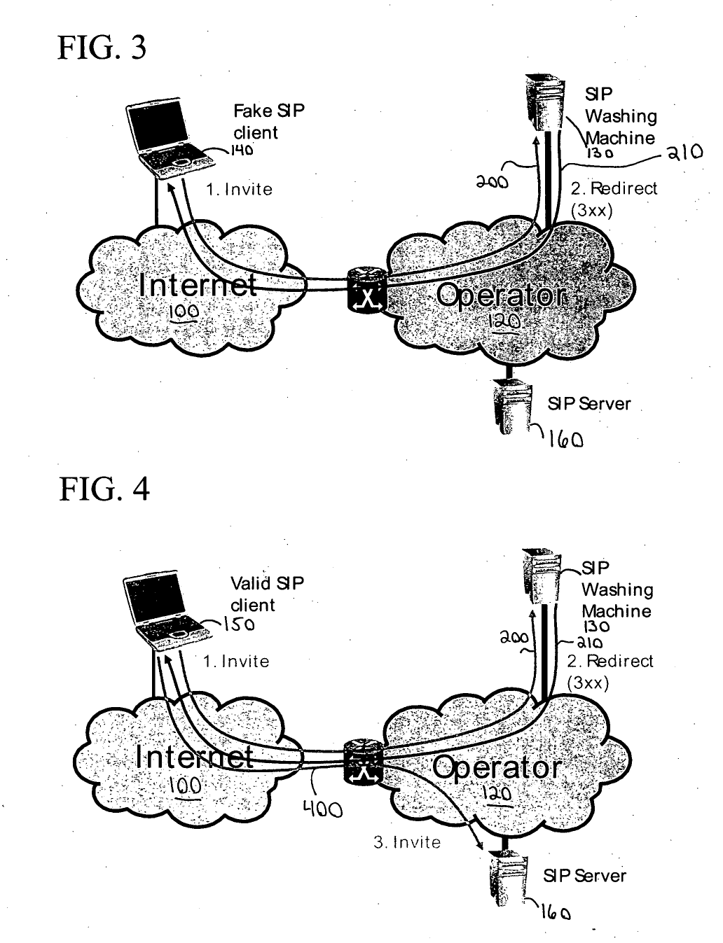

FIGS. 3 and 4 show the consequences of the use of the SIP washing machine 130 for both a “fake” client 140 (a client device attempting a DoS attack) and a legitimate SIP client 150. In FIG. 3, the redirection request from the SIP washing machine 130 is transmitted to the fake client 140. The fake client 140 does not understand the redirection request and is therefore unable to respond by following the redirection request, effectively preventing the DoS attack from succeeding. In FIG. 4, on the other hand, the legitimate SIP client 150 understands the redirection request and follows its instruction by transmitting a new message to the alternate SIP device 160 specified by the SIP washing machine 130. This new message is represented at 400 and allows the operator 120 to continue its standard operations and functions.

In various embodiments of the present invention, the SIP washing machine 130 discussed above can also implement washing functionality for SYN floods, as SYN floods can also be used to bring down SIP servers. Additionally, the SIP washing machine 130 can be even more universal in nature, such that it can be used also for non-SIP services as well.

The functionality of a SIP washing machine 130 of the present invention can be kept quite simple in order to make it scalable. For example, the redirection of traffic can comprise a static function that automatically replies to incoming SIP messages with a redirection. In other embodiments of the invention, the SIP washing machine 130 may perform additional functions as well, such as checking registration credentials of clients that have transmitted messages or requests.

FIG. 5 shows the circuitry that can appear in one representative electronic device within which the present invention may be implemented. It should be understood, however, that the present invention is not intended to be limited to one particular type of electronic device. The electronic device of FIG. 5 includes a display 32, a keypad 34, a microphone 36, an ear-piece 38, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of managing a denial of service attack, comprising:
determining whether a plurality of incoming SIP messages being received are part of a denial of service attack; and
if the plurality of incoming SIP messages being received are part of a denial of service attack, redirecting all incoming SIP messages to a SIP washing machine, the SIP washing machine responding to each incoming SIP message with a SIP response requesting that the originator of the respective SIP message redirect its SIP message to an alternate IP address.

2. The method of claim 1, wherein SIP proxy statistics are used to determine whether the plurality of incoming SIP messages are part of a denial of service attack.

3. The method of claim 1, wherein an IP routing protocol is used to redirect all incoming SIP messages to the SIP washing machine.

4. The method of claim 3, wherein the alternate IP address represents an alternate SIP server.

5. The method of claim 3, wherein the alternate IP address represents an alternative address for a SIP server which received the plurality of SIP messages.

6. A computer program product, embodied in a computer-readable medium, for managing a denial of service attack, comprising:
computer code for determining whether a plurality of incoming SIP messages being received are part of a denial of service attack; and
computer code for, if the plurality of incoming SIP messages being received are part of a denial of service attack, redirecting all incoming SIP messages to a SIP washing machine, the SIP washing machine responding to each incoming SIP message with a SIP response requesting that the originator of the respective SIP message redirect its SIP message to an alternate IP address.

7. The computer program product of claim 6, wherein SIP proxy statistics are used to determine whether the plurality of incoming SIP messages are part of a denial of service attack.

8. The computer program product of claim 6, wherein an IP routing protocol is used to redirect all incoming SIP messages to the SIP washing machine.

9. The computer program product of claim 8, wherein the alternate IP address represents an alternate SIP server.

10. The computer program product of claim 8, wherein the alternate IP address represents an alternative address for a SIP server which received the plurality of SIP messages.

11. A SIP server configured to manage a denial of service attack, comprising:
a memory unit; and
a processor communicatively connected to the memory unit and including:
computer code for determining whether a plurality of incoming SIP messages being received are part of a denial of service attack; and
computer code for, if the plurality of incoming SIP messages being received are part of a denial of service attack, redirecting all incoming SIP messages to a SIP washing machine, the SIP washing machine responding to each incoming SIP message with a SIP response requesting that the originator of the respective SIP message redirect its SIP message to an alternate IP address.

12. The SIP server of claim 11, wherein SIP proxy statistics are used to determine whether the plurality of incoming SIP messages are part of a denial of service attack.

13. The SIP server of claim 11, wherein an IP routing protocol is used to redirect all incoming SIP messages to the SIP washing machine.

14. The SIP server of claim 13, wherein the alternate IP address represents an alternate SIP server.

15. The SIP server of claim 13, wherein the alternate IP address represents an alternative address for the SIP server.

16. A method of managing a denial of service attack, comprising:
receiving redirected incoming SIP messages originally directed to a SIP server, at least some of the redirected incoming SIP messages being part of a denial of service attack; and
transmitting a response SIP message to an originator of each of the redirected incoming SIP messages, the response requesting that the originator of the respective SIP message redirect its SIP message to an alternate IP address.

17. The method of claim 16, wherein the alternate IP address represents an alternate SIP server.

18. The method of claim 16, wherein the alternate IP address represents an alternative address for a SIP server which initially received the plurality of SIP messages.

19. A computer program product, embodied in a computer-readable medium, for managing a denial of service attack, comprising:
computer code for receiving redirected incoming SIP messages originally directed to a SIP server, at least some of the redirected incoming SIP messages being part of a denial of service attack; and
computer code for transmitting a response SIP message to an originator of each of the redirected incoming SIP messages, the response requesting that the originator of the respective SIP message redirect its SIP message to an alternate IP address.

20. The computer program product of claim 19, wherein the alternate IP address represents an alternate SIP server.

21. The computer program product of claim 19, wherein the alternate IP address represents an alternative address for a SIP server which initially received the plurality of SIP messages.

22. A SIP washing machine configured to manage a denial of service attack, comprising:
a processor; and
a memory unit communicatively connected to the processor and including:
computer code for receiving redirected incoming SIP messages originally directed to a SIP server, at least some of the redirected incoming SIP messages being part of a denial of service attack; and
computer code for transmitting a response SIP message to an originator of each of the redirected incoming SIP messages, the response requesting that the originator of the respective SIP message redirect its SIP message to an alternate IP address.

23. The SIP washing machine of claim 22, wherein the alternate IP address represents an alternate SIP server.

24. The SIP washing machine of claim 22, wherein the alternate IP address represents an alternative address for a SIP server which initially received the plurality of SIP messages.
